(19) United States
(12) Patent Application Publication
(10) Pub. No.: US 2009/0211818 A1
(43) Pub. Date: Aug. 27, 2009

(54) INPUT DEVICE

(76) Inventors: Takashi Kondo, Fukushima-ken (JP); Sadakazu Shiga, Fukushima-ken (JP); Shingo Kishino, Fukushima-ken (JP)

Correspondence Address: BRINKS HOFER GILSON & LIONE, P.O. BOX 10395, CHICAGO, IL, 60610, US

(21) Appl. No.: 12/366,018

(22) Filed: Feb. 5, 2009

(30) Foreign Application Priority Data
Feb. 21, 2008 (JP) 2008-040091

(51) Int. Cl. G06F 3/041

(52) U.S. Cl. 178/18.03

(57) ABSTRACT

Disclosed is an input device capable of decreasing the number of layers of a detecting portion to reduce manufacturing costs and easily deforming layers provided above a pressure sensitive detecting portion. A capacitance-type detecting portion that detects the contact position of a finger on the basis of a variation in capacitance is provided on a pressure sensitive detecting portion that includes a lower detection layer formed on a lower base sheet and an upper detection layer formed on an upper base sheet. A voltage is applied to the pressure sensitive detecting portion and the capacitance-type detecting portion such that the application times of the voltages do not overlap each other. Therefore, it is possible to prevent interference between the detection operations of the two detecting portions.

### CLAIM OF PRIORITY

This application claims benefit of the Japanese Patent Application No. 2008-40092 filed on Feb. 21, 2008, the entire content of which is hereby incorporated by reference.

### BACKGROUND

1. Technical Field

The present disclosure relates to an input device in which a pressure sensitive detecting portion that detects a pressed position on the basis of a variation in resistance value overlaps a capacitance-type detecting portion that detects the approach position of an indicator, such as a finger, on the basis of a variation in capacitance, and which is formed of a soft material, has a small thickness, and can maintain the detection accuracy of the detecting portions at a high level.

2. Related Art

JP-A-2001-243010 discloses an input device provided in, for example, a personal computer. In the disclosed input device, a capacitance-type detecting portion that detects the approach of a conductive indicator, such as a finger, on the basis of a variation in capacitance is provided on a pressure sensitive detecting portion that detects a pressed position on the basis of a variation in resistance value. In the upper capacitance-type detecting portion, electrodes are formed on a flexible resin film.

When an indicator, such as a finger, contacts the surface of the input device, the capacitance-type detecting portion can detect the contact position. In addition, when the surface of the input device is pressed by, for example, an input pen, the capacitance-type detecting portion is deformed and the pressure sensitive detecting portion provided below the capacitance-type detecting portion is operated to detect the position pressed by the input pen.

In the input device, when a voltage is applied to a conductive layer or a resistor layer of the pressure sensitive detecting portion, the detection accuracy of the variation in capacitance by the capacitance-type detecting portion is significantly lowered due to charge in the layer, and it is difficult to use the capacitance-type detecting portion. Therefore, generally, a shield layer, which is a conductive layer having a ground potential, is interposed between the pressure sensitive detecting portion and the capacitance-type detecting portion.

As described above, when the shield layer is provided between the pressure sensitive detecting portion and the capacitance-type detecting portion, the number of layers of the two detecting portions increases. As a result, manufacturing costs increase, and it is difficult to reduce the thickness of an input device.

In general, the shield layer is a metal layer. However, when a metal layer is provided on the pressure sensitive detecting portion, the rigidity of layers disposed above the pressure sensitive detecting portion is increased by the metal layer. Therefore, when the surface of the input device is pressed by, for example, an input pen, the entire input device is not easily deformed, and the detection accuracy of the pressure sensitive detecting portion is lowered.

### SUMMARY

According to an aspect of the invention, an input device includes: a pressure sensitive detecting portion that includes a lower detection layer and an upper detection layer facing each other with a gap therebetween, and detects a contact position between the lower detection layer and the upper detection layer on the basis of a variation in resistance value; and a capacitance-type detecting portion that includes a plurality of X driving electrodes and a plurality of Y driving electrodes which face each other with an insulating layer interposed therebetween and extend in directions orthogonal to each other, and detects a position where an indicator approaches on the basis of a variation in the capacitance between the electrodes. The capacitance-type detecting portion is formed on the pressure sensitive detecting portion, and a flexible cover sheet is formed on the capacitance-type detecting portion. The upper detection layer is formed of a flexible resin sheet. The X driving electrodes, the Y driving electrodes, and the insulating layer are formed of flexible resin sheets. The upper detection layer and the X driving electrodes or the Y driving electrodes provided at a lower side are arranged in the vertical direction without a metal layer interposed therebetween.

In the input device according to the above-mentioned aspect of the invention, no metal shield layer is provided between the pressure sensitive detecting portion and the capacitance-type detecting portion provided on the pressure sensitive detecting portion. Therefore, it is possible to decrease the number of layers of the detecting portions and reduce the thickness of an input device. In addition, it is possible to reduce manufacturing costs. Further, since no metal layer is provided, it is possible to reduce the rigidity of layers provided above the pressure sensitive detecting portion. Therefore, when the surface of the input device is pressed, it is easy to operate the pressure sensitive detecting portion.

### BRIEF DESCRIPTION OF THE DRAWINGS

FIG. 1 is an exploded perspective view illustrating an input device according to a first embodiment of the invention,

FIG. 2 is an exploded perspective view illustrating the structure of a capacitance-type detecting portion of the input device according to the first embodiment,

FIG. 3 is a cross-sectional view illustrating the input device according to the first embodiment of the invention taken along the line III-III of FIG. 1,

FIG. 4 is a cross-sectional view illustrating an input device according to a second embodiment of the invention taken along the line III-III of FIG. 1, and

FIG. 5 is a block diagram illustrating the circuit structure of the input device.

### DESCRIPTION OF EXEMPLARY EMBODIMENTS

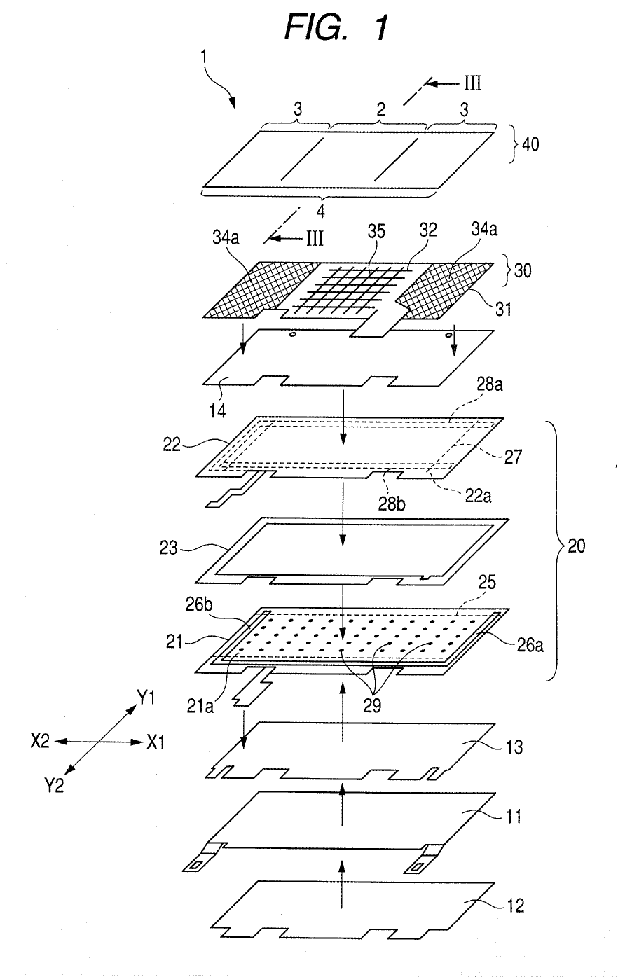

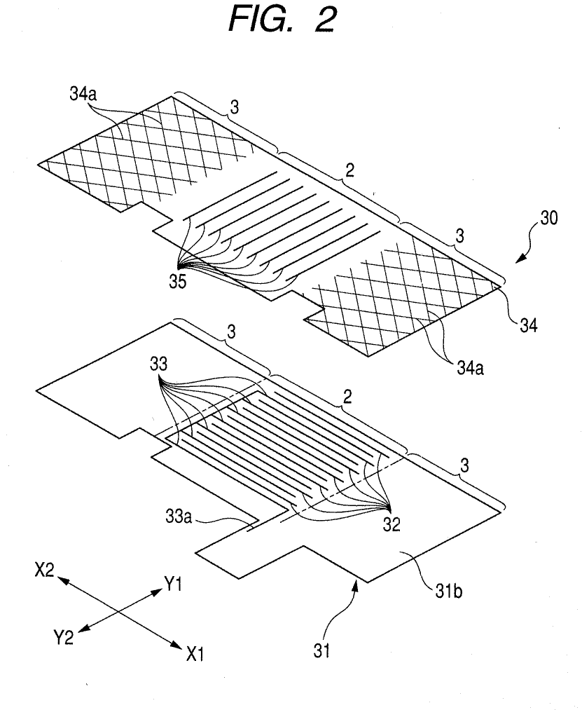

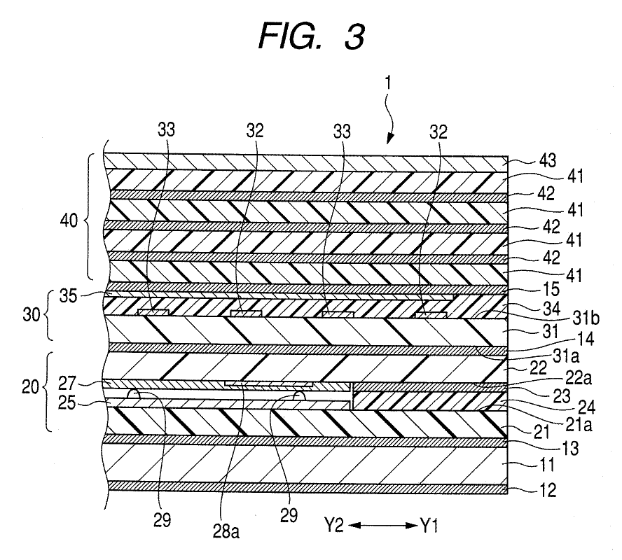

FIG. 1 is an exploded perspective view illustrating an input device according to a first embodiment of the invention. FIG. 2 is an exploded perspective view illustrating the structure of a pressure sensitive detecting portion of the input device. FIG. 3 is a partial enlarged cross-sectional view illustrating the input device according to the first embodiment taken along the line III-III of FIG. 1.

As shown in FIGS. 1 and 2, an input device 1 according to the first embodiment has a rectangular shape having a long side aligned with the X direction and a short side aligned with the Y direction. The center of the input device 1 in the X direction is an electrostatic detection region 2, and both sides of the center are extending portions 3. Substantially the entire region including the electrostatic detection region 2 and the extending portions 3 is a pressure detection region 4. FIG. 3 is a traverse cross-sectional view of an electrostatic detection region 2.

A laminated structure of the input device 1 will be described with reference to FIGS. 1 and 3.

A substrate 11 is provided at a lowest part of the input device 1. The substrate 11 is a metal plate. When a point of the pressure detection region 4 is pressed from the upper side, the substrate 11 is supported from the lower side such that the input device 1 is not easily deformed. A double-sided adhesive tape 12 is adhered to a lower surface of the substrate 11. The input device is fixed to, for example, an operation board of a personal computer by the double-sided adhesive tape 12 provided at the lowest side. The double-sided adhesive tape 12 has a three-layer structure in which a pressure sensitive adhesive layer is formed on both surfaces of a thin synthetic resin film. However, in the cross-sectional view of FIG. 3, each of the double-sided adhesive tape 12 and other double-sided adhesive tapes 13, 14, 15, and 23 is shown as a single layer.

The double-sided adhesive tape 13 is provided on an upper surface of the substrate 11, and layers of a pressure sensitive detecting portion 20 are formed on the double-sided adhesive tape 13. The double-sided adhesive tape 14 is provided on the pressure sensitive detecting portion 20, and a capacitance-type detecting portion 30 is provided on the double-sided adhesive tape 14. In addition, a cover sheet 40 is adhered to the upper surface of the capacitance-type detecting portion 30 with the double-sided adhesive tape 15 interposed therebetween.

Instead of the double-sided adhesive tapes 12, 13, 14, and 15, an adhesive layer may be used to adhere the upper and lower layers of the adhesive layer.

The pressure sensitive detecting portion 20 includes a lower base sheet 21 and an upper base sheet 22 provided on the lower base sheet. The lower base sheet 21 and the upper base sheet 22 are adhered to each other by the double-sided adhesive tape 23. As shown in FIG. 1, the double-sided adhesive tape 23 has a frame shape that adheres the edge of the lower base sheet 21 and the edge of the upper base sheet 22.

Instead of the double-sided adhesive tape 23, a frame-shaped adhesive layer or a frame-shaped film adhesive may be used. The double-sided adhesive tape 23 has a function of maintaining a gap between the lower base sheet 21 and the upper base sheet 22 in the vertical direction. Therefore, instead of the double-sided adhesive tape 23, a spacer, such as a frame-shaped resin sheet, may be used, and the spacer may be adhered by an adhesive.

The lower base sheet 21 may be a synthetic resin sheet or a synthetic resin film made of, for example, a polyimide resin or an olefin-based resin, such as PET (polyethylene terephthalate) or PEN (polyethylene naphthalate). As shown in FIG. 3, an insulating layer 24 that is patterned in a frame shape is provided on an upper surface 21a of the lower base sheet 21. The insulating layer 24 may be formed of a polyimide-based or olefin-based insulating resin, and is called a resist. The insulating layer 24 may be formed in the same pattern as the double-sided adhesive tape 23 having a frame shape on the upper surface 21a of the lower base sheet 21. A lower detection layer 25 may be formed in a region surrounded by the insulating layer 24 on the upper surface 21a of the lower base sheet 21. As shown in FIG. 1, an X1 connection electrode 26a that is connected to the lower detection layer 25 is provided on an X1 side, and an X2 connection electrode 26b that is connected to the lower detection layer 25 is provided on an X2 side on the upper surface 21a.

The upper base sheet 22 is also a synthetic resin sheet or a synthetic resin film made of, for example, PET, PEN, or polyimide, and is flexible. An upper detection layer 27 is formed in a region surrounded by the frame-shaped double-sided adhesive tape 23 on a lower surface 22a of the upper base sheet 22. As shown in FIG. 1, a Y1 connection electrode 28a that is connected to the upper detection layer 27 is provided on a Y1 side, and a Y2 connection electrode 28b that is connected to the upper detection layer 27 is provided on a Y2 side on the lower surface 22a.

A plurality of spacer convex portions 29 are formed on the upper surface of the lower detection layer 25 at predetermined intervals. The spacer convex portion 29 may be formed of a resist, similar to the insulating layer 24. The plurality of spacer convex portions 29 form a gap between the lower detection layer 25 and the upper detection layer 27. In addition, when pressing force is applied to a part of the upper base sheet 22 from the upper side and the upper base sheet 22 is partially deformed downward, the upper detection layer 27 and the lower detection layer 25 are partially connected with each other between adjacent spacer convex portions 29.

The lower detection layer 25 and the upper detection layer 27 are resistor layers, and may be formed of a mixture of a binder resin and conductive powder, such as carbon. The lower detection layer 25 is formed in a plate shape with a uniform thickness on the upper surface 21a of the lower base sheet 21 and in the region surrounded by the frame-shaped insulating layer 24. Similarly, the upper detection layer 27 is formed in a plate shape with a uniform thickness on the lower surface 22a of the upper base sheet 22 and in the region surrounded by the frame-shaped double-sided adhesive tape 23.

Any of the following is used as the X1 connection electrode 26a and the X2 connection electrode 26b: an aluminum or copper foil tape; an electrode obtained by baking a conductive layer made of a mixture of a binder resin and conductive metal powder, such as silver powder; an electrode formed by performing printing with paste having silver powder or gold powder mixed therewith; an electrode obtained by adhering a resin sheet having an electrode pattern formed thereon to a silver layer. The X1 connection electrode 26a and the X2 connection electrode 26b have a specific resistance that is less than that of the lower detection layer 25. The Y1 connection electrode 28a and the Y2 connection electrode 28b are formed by the same method as described above, and have a specific resistance that is less than that of the upper detection layer 27.

In the pressure sensitive detecting portion 20, the lower detection layer 25 faces the upper detection layer 27 in substantially the entire region surrounded by the frame-shaped double-sided adhesive tape 23 and the frame-shaped insulating layer 24, and substantially the entire region in the frame is a region capable of detecting a pressed position, that is, the pressure detection region 4.

As shown in FIGS. 2 and 3, the capacitance-type detecting portion 30 includes a base sheet 31. The base sheet 31 is a synthetic resin sheet or a synthetic resin film made of, for example, PET, PEN, or polyimide, and is flexible. The base sheet 31 has a lower surface 31a that is directly adhered to the double-sided adhesive tape 14 and an upper surface 31b on which layers for detecting a variation in capacitance are formed.

As shown in FIGS. 2 and 3, a plurality of Y driving electrodes 32 and a plurality of detection electrodes 33 are formed on the upper surface 31b of the base sheet 31. The plurality of Y driving electrodes 32 are formed at predetermined pitches in the Y direction, and extend in a straight line in the X direction. Lead patterns which sequentially supplies driving power to the plurality of Y driving electrodes 32 and whose number is equal to the number of Y driving electrodes 32 are provided on the upper surface 31b of the base sheet 31. In FIG. 2, the lead patterns are omitted.

The detection electrode 33 is disposed between adjacent Y driving electrodes 32. The detection electrodes 33 are arranged at predetermined pitches in the Y direction and extend in a straight line in the X direction. The plurality of detection electrodes 33 extend to the outside as one detection line 33a. The Y driving electrodes 32 and the detection electrodes 33 are patterned with a low-resistance conductive material, similar to the X1 connection electrode 26a or the X2 connection electrode 26b provided in the pressure sensitive detecting portion 20.

After the Y driving electrodes 32 and the detection electrodes 33 are patterned on the upper surface 31b of the base sheet 31, an insulating layer 34 is formed thereon. The insulating layer 34 is made of an insulating resin, such as resist, and is formed by applying a liquid insulating resin so as to cover the Y driving electrodes 32 and the detection electrodes 33 and hardening it. Alternatively, a protective sheet made of a synthetic resin may be adhered by a pressure sensitive adhesive so as to cover the Y driving electrodes 32 and the detection electrodes 33, thereby forming the insulating layer 34.

After the insulating layer 34 is hardened, X driving electrodes 35 are formed on the insulating layer 34. As shown in FIG. 2, the X driving electrodes 35 are arranged at predetermined pitches in the X direction and extend in a straight line in the Y direction. The X driving electrodes 35 are patterned on the upper surface of the insulating layer 34 by the same means as that for patterning the Y driving electrodes 32. Lead patterns which sequentially supplies driving power to the plurality of X driving electrodes 35 and whose number is equal to the number of the X driving electrodes 35 are provided on the upper surface of the insulating layer 34. In FIG. 2, the lead patterns are omitted.

As shown in FIG. 2, in the electrostatic detection region 2 of the capacitance-type detecting portion 30, the Y driving electrodes 32 and the detection electrodes 33 face the X driving electrodes 35 with the insulating layer 34 interposed therebetween. The extending portions 3 are formed on the left and right sides of the electrostatic detection region 2 in the capacitance-type detecting portion 30. However, the extending portions 3 do not have a function of detecting capacitance.

The insulating layer 34 is formed with a uniform thickness over the electrostatic detection region 2 and the extending portions 3. The electrostatic detection region 2 and the extending portions 3 are all arranged on the pressure detection region 4. Since the electrostatic detection region 2 and the extending portions 3 are formed on the insulating layer 34 with a uniform thickness, the same touch pressure is required to deform the upper base sheet 22 in the pressure detection region 4 when the electrostatic detection region 2 of the input device 1 is pressed by an input pen and when the extending portions 3 of the input device 1 are pressed by the input pen.

As shown in FIG. 2, in the extending portions 3, a plurality of grooves or a plurality of linear cutout portions are patterned in the insulating layer 34, and these grooves or cutout portions serve as air passages 34a. When a cover sheet is adhered to the capacitance-type detecting portion 30 with the double-sided adhesive tape 15 interposed therebetween, air between the capacitance-type detecting portion 30 and the double-sided adhesive tape 15 is easily exhausted to the outside through the air passages 34a, and air is less likely to remain in an adhesive interface.

In the extending portions 3, a plurality of air passages 34a intersect each other and are inclined with respect to the X direction and the Y direction. Therefore, during a process of adhering the cover sheet 40 to the capacitance-type detecting portion 30 having an elongated rectangular shape with the double-sided adhesive tape 15 interposed therebetween so as to be aligned with the X1 direction or the X2 direction, air is easily exhausted to the outside through the air passages 34a.

As shown in FIG. 3, the cover sheet 40 is adhered and fixed to the capacitance-type detecting portion 30 by the double-sided adhesive tape 15. The cover sheet 40 disposed on the capacitance-type detecting portion 30 is formed by laminating a plurality of flexible resin sheets (or resin films) 41 made of, for example, PET or polycarbonate, and adhering the resin sheets 41 by acryl-based pressure sensitive adhesive layers 42. When the cover sheet 40 is formed by laminating a plurality of resin sheets 41, it is possible to obtain a flexible cover sheet 40 that is easily deformed. In addition, it is possible to set the distance between the capacitance-type detecting portion 30 and the surface of the cover sheet 40 to an optimal value capable of improving sensitivity to a variation in capacitance detected by the capacitance-type detecting portion 30 when a finger is touched.

For example, about four resin sheets 41 having a thickness in the range of about 0.1 to 0.2 mm may be laminated to form a flexible cover sheet 40 having a thickness of about 0.5 to 0.8 mm.

A hard coat layer 43 made of, for example, an acrylic resin, is formed on the outer surface of the cover sheet 40 to prevent the surface of the cover sheet 40 from being damaged. The hard coat layer 43 may be omitted.

The upper base sheet 22 disposed at an upper part of the pressure sensitive detecting portion 20 and the base sheet 31 disposed above the pressure sensitive detecting portion 20 each have a thickness of about 0.1 to 0.5 mm, and these base sheets are configured so as to be easily deformed by pressure applied from the upper side. In particular, no metal shield layer is interposed between the pressure sensitive detecting portion 20 and the capacitance-type detecting portion 30. Therefore, when the surface of the cover sheet 40 is pressed by, for example, an input pen, it is easy for the lower detection layer 25 and the upper detection layer 27 to be partially contacted with each other in the pressure sensitive detecting portion 20.

As shown in FIG. 1, the input device 1 can be simply assembled by sequentially laminating the lower base sheet 21, the upper base sheet 22, the base sheet 31 of the capacitance-type detecting portion 30, and the cover sheet 40 on the substrate 11 and adhering these layers with the double-sided adhesive tapes 12, 23, 14, and 15.

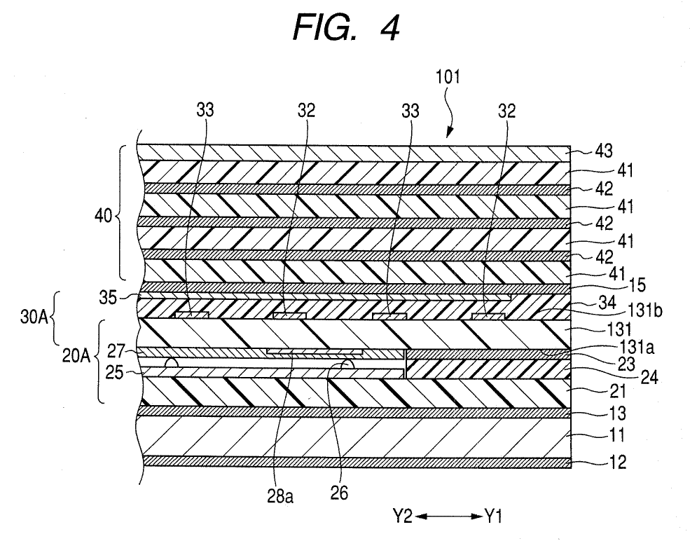

FIG. 4 is a cross-sectional view illustrating an input device 101 according to a second embodiment of the invention, and shows the same part as that in FIG. 3. In the input device 101 shown in FIG. 4, the same components as those in the input device 1 according to the first embodiment are denoted by the same reference numerals, and a description thereof will be omitted.

In the input device 101 shown in the FIG. 4, the upper detection layer 27, the Y1 connection electrode 28a, and the Y2 connection electrode 28b are formed on a lower surface 131a of a base sheet 131, which is a synthetic resin sheet made of, for example, PET, and the Y driving electrodes 32 and the detection electrodes 33 are formed on an upper surface 131b of the base sheet 131. In addition, the insulating layer 34 is formed on the Y driving electrodes and the detection electrodes, and the X driving electrodes 35 are formed on the insulating layer 34. Similar to FIG. 2, in the extending portions 3, the air passages 34a are formed in the insulating layer 34.

In the input device 101 shown in FIG. 4, a pressure sensitive detecting portion 20A is formed between the lower base sheet 21 and the base sheet 131, and a capacitance-type detecting portion 30A is formed on the base sheet 131. That is, one base sheet 131 serves as the upper base sheet 22 and the base sheet 31 of the input device 1 shown in FIG. 3.

Therefore, in the input device 101 shown in FIG. 4, one base sheet and one double-sided adhesive tape 14 can be omitted from the input device 1 shown in FIG. 3. As a result, the number of layers provided above the pressure sensitive detecting portion 20A can be decreased, and it is possible to reduce manufacturing costs and the thickness of an input device. In addition, the upper detection layer 27 of the pressure sensitive detecting portion 20A is formed on the lower surface 131a of the base sheet 131, and the Y driving electrodes 32 and the detection electrodes 33 of the capacitance-type detecting portion 30A are formed on the upper surface 131b of the base sheet 131. Therefore, it is possible to reduce the thickness of an input device and obtain a flexible input device, as compared to a structure in which a sheet for a shield layer is interposed between the pressure sensitive detecting portion 20A and the capacitance-type detecting portion 30A.

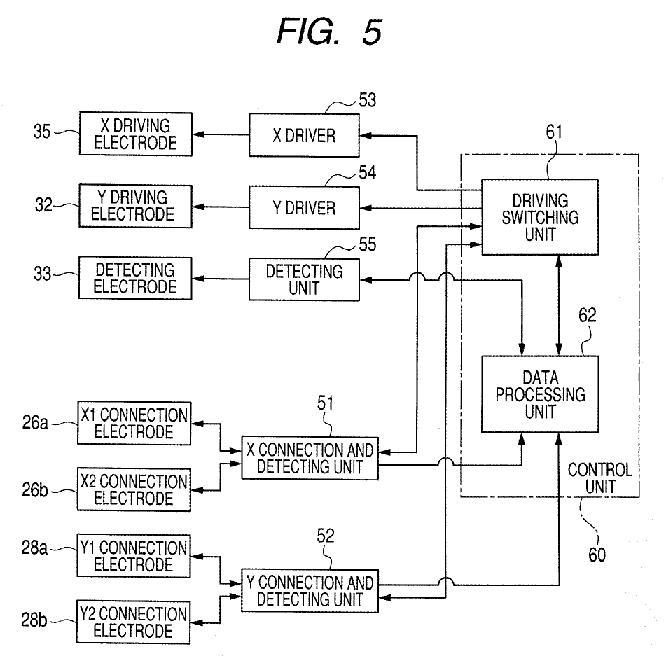

FIG. 5 is a block diagram illustrating the circuit structure of the input device 1. The circuit structure can be similarly used for the input device 101 shown in FIG. 4.

The circuit shown in FIG. 5 includes: an X connection detecting unit 51 that is connected to the X1 connection electrode 26a and the X2 connection electrode 26b of the pressure sensitive detecting portion 20, a Y connection detecting unit 52 that is connected to the Y1 connection electrode 28a and the Y2 connection electrode 28b; an X driver 53 that sequentially supplies driving power to a plurality of X driving electrodes 35 of the capacitance-type detecting portion 30; a Y driver 54 that sequentially supplies driving power to a plurality of Y driving electrodes 32; and a detecting unit 55 that detects a variation in the current value of the detection line 33a which is commonly connected to the plurality of detection electrodes 33.

Although not shown in FIG. 5, the circuit further includes a power supply circuit for a pressure sensitive detecting portion that supplies power to the X connection detecting unit 51 and the Y connection detecting unit 52, and a power supply circuit for a capacitance-type detecting portion that supplies power to the X driver 53 and the Y driver 54.

A control unit 60 includes a driving switching unit 61 and a data processing unit 62. The driving switching unit 61 switches the supply timing of a voltage from the X connection detecting unit 51 to the X1 connection electrode 26a and the X2 connection electrode 26b and the supply timing of a voltage from the Y connection detecting unit 52 to the Y1 connection electrode 28a and the Y2 connection electrode 28b. Similarly, the driving switching unit 61 switches the supply timing of driving power from the X driver 53 to the X driving electrodes 35 and the supply timing of driving power from the Y driver 54 to the Y driving electrodes 32.

A detection signal generated by the detecting unit 55 and detection signals generated by the X connection detecting unit 51 and the Y connection detecting unit 52 are transmitted to the data processing unit 62.

Next, the operation of the input device 1 will be described.

In the pressure sensitive detecting portion 20, a voltage is applied between the X1 connection electrode 26a and the X2 connection electrode 26b, and a voltage is applied between the Y1 connection electrode 28a and the Y2 connection electrode 28b. However, the voltage is alternately applied to the X1 and X2 connection electrodes 26a and 26b and the Y1 and Y2 connection electrodes 28a and 28b so as not to temporally overlap each other.

When a constant voltage is applied between the X1 connection electrode 26a and the X2 connection electrode 26b, the surface of the cover sheet 40 is partially pressed by an input pen, and the upper detection layer 27 and the lower detection layer 25 are contacted with each other at any point of the pressure detection region 4, resistance values between the Y1 and Y2 connection electrodes 28a and 28b and the X1 connection electrode 26a or the X2 connection electrode 26b are changed, and the voltage varies depending on the change in the resistance values. Therefore, it is possible to detect the position of the contact point in the X direction on the basis of the variation in the voltage. In addition, when a constant voltage is applied between the Y1 connection electrode 28a and the Y2 connection electrode 28b and the upper detection layer 27 and the lower detection layer 25 are contacted with each other at any point of the pressure detection region 4, the voltage between the X1 and X2 connection electrodes 26a and 26b and the Y1 connection electrode 28a or the Y2 connection electrode 28b varies. Therefore, it is possible to detect the position of the contact point in the Y direction on the basis of the variation in the voltage.

The variation in the voltage is transmitted from the X connection detecting unit 51 or the Y connection detecting unit 52 to the data processing unit 62, and the data processing unit 62 can detect the position of the contact point between the upper detection layer 27 and the lower detection layer 25, that is, the position of a portion of the pressure detection region 4 pressed by, for example, an input pen.

In the capacitance-type detecting portion 30, a pulse voltage is sequentially applied from the X driver 53 to a plurality of X driving electrodes 35, and a pulse voltage is sequentially applied from the Y driver 54 to a plurality of Y driving electrodes 32. In this case, the voltages are applied so as not to temporally overlap each other. Then, capacitance is formed between the X driving electrode 35 and the detection electrode 33. When a pulse voltage is applied to any one of the X driving electrodes 35, a current instantaneously flows between the X driving electrode 35 and the detection electrode 33. However, when a finger, which is a conductive indicator having a substantially ground potential, contacts the surface of the cover sheet 40, capacitance that is sufficiently larger than the capacitance between the electrodes is formed between the finger and the X driving electrode 35 that is closest to the finger. Therefore, when a pulse voltage is applied to the X driving electrode 35 closest to the finger, a current flows to the finger, and the amount of current instantaneously flowing between the X driving electrode 35 and the detection electrode 33 is reduced.

The detecting unit 55 converts a current value that instantaneously flows between the X driving electrode 35 and the detection electrode 33 into a voltage value, and transmits the voltage value to the data processing unit 62. The data processing unit 62 can calculate the X coordinate of the point which the finger approaches, on the basis of information indicating the X driving electrode 35 to which the pulse voltage is applied and the voltage value obtained by the detecting unit 55. Similarly, the data processing unit 62 can calculate the Y coordinate of the point which the finger approaches, on the basis of information indicating the Y driving electrode 32 to which the pulse voltage is applied and the voltage value obtained by the detecting unit 55.

When a voltage is applied from the X driver 53 to the X driving electrode 35 and when a voltage is applied from the Y driver 54 to the Y driving electrode 32, the driving switching unit 61 performs switching such that no voltage is applied to the X1 and X2 connection electrodes 26a and 26b and the Y1 and Y2 connection electrodes 28a and 28b.

For example, the driving switching unit 61 repeatedly performs the switching operation at a predetermined interval such that the time when a voltage is applied to the X driving electrode 35, the time when a voltage is applied to the Y driving electrode 32, the time when a voltage is applied to the X1 connection electrode 26a and the X2 connection electrode 26b, and the time when a voltage is applied to the Y1 connection electrode 28a and the Y2 connection electrode 28b do not overlap each other.

When the capacitance-type detecting portion 30 detects the contact point of the finger on the basis of a variation in capacitance, no voltage is applied to the pressure sensitive detecting portion 20. Therefore, it is possible to prevent the detection accuracy of the variation in capacitance from being significantly lowered due to the application of a voltage to the pressure sensitive detecting portion 20.

Therefore, the user can lightly touch the electrostatic detection region 2 on the surface of the cover sheet 40 of the input device 1 with a finger to input the X and Y coordinates. In addition, the user can strongly press the surface of the cover sheet 40 with, for example, an input pen to operate the pressure sensitive detecting portion 20, thereby inputting the X and Y coordinates in the wide pressure detection region 4.

As another switching method, a voltage may be alternately applied to the X driving electrode 35 and the Y driving electrode 32, and a voltage may be intermittently applied to the pressure sensitive detecting portion 20 at a time interval that is longer than the time for which a voltage is applied to the X driving electrode 35 and the Y driving electrode 32 such that the time when a voltage is applied to the X driving electrode 35 does not overlap the time when a voltage is applied to the Y driving electrode 32.

In this case, the operation of the capacitance-type detecting portion 30 has first priority, and it is possible to detect the contact of a finger on the basis of a variation in capacitance all the time. When the strong pressure of a part of the cover sheet 40 by, for example, an input pen is detected by the intermittent operation of the pressure sensitive detecting portion 20, the application of a voltage to the X driving electrode 35 and the Y driving electrode 32 stops, and a voltage starts to be alternately applied to the X1 and X2 connection electrodes 26a and 26b and the Y1 and Y2 connection electrodes 28a and 28b. In this way, it is possible to perform a detection operation of the pressure sensitive detecting portion 20. In this case, a detection output from the pressure sensitive detecting portion 20 is not obtained. Therefore, after a predetermined time has elapsed, a voltage is alternately applied to the X driving electrode 35 and the Y driving electrode 32 such that the detection operation of the capacitance-type detecting portion 30 starts.

The surface of the cover sheet 40 includes the electrostatic detection region 2 and the extending portions 3, and boundary lines are printed between the electrostatic detection region 2 and the extending portions 3. Alternatively, the electrostatic detection region 2 may slightly protrude from the extending portions 3 on the surface of the cover sheet 40 such that the user can easily perceive the range of the electrostatic detection region 2 by the tough.

Next, a modification of the input device 101 shown in FIG. 4 will be described. In the modification, the Y driving electrodes 32 and the detection electrodes 33 may be formed on the lower surface 131a of the base sheet 131, and the X driving electrodes 35 may be formed on the upper surface 131b of the base sheet 131, thereby forming a capacitance-type detecting portion. In addition, an insulating layer may be formed so as to cover the Y driving electrodes 32 and the detection electrodes 33 formed on the lower surface 131a of the base sheet 131, and the upper detection layer 27, the Y1 connection electrode 28a, and the Y2 connection electrode 28b may be formed on the lower surface of the insulating layer.

Further, the pressure sensitive detecting portion 20 may have a following structure: one of the lower detection layer and the upper detection layer is formed of a resistor film; the other layer is formed of a conductive film having a resistance value that is lower than that of the resistor film; a voltage is alternately applied to the resistor film in the X direction and the Y direction to detect a variation in potential from the conductive film, thereby detecting the X and Y coordinates of the contact position between the lower detection layer and the upper detection layer. As another structure of the pressure sensitive detecting portion 20, electrodes may be formed at four corners of the resistor film, and a voltage may be applied to detect the contact position with a conductive film.

What is claimed is:

1. An input device comprising:
a pressure sensitive detecting portion that includes a lower detection layer and an upper detection layer facing each other with a gap therebetween, and detects a contact position between the lower detection layer and the upper detection layer on the basis of a variation in resistance value; and
a capacitance-type detecting portion that includes a plurality of X driving electrodes and a plurality of Y driving electrodes which face each other with an insulating layer interposed therebetween and extend in directions orthogonal to each other, and detects a position where an indicator approaches on the basis of a variation in the capacitance between the electrodes,
wherein the capacitance-type detecting portion is formed on the pressure sensitive detecting portion, and a flexible cover sheet is formed on the capacitance-type detecting portion,
the upper detection layer is formed of a flexible resin sheet,
the X driving electrodes, the Y driving electrodes, and the insulating layer are formed of flexible resin sheets, and
the upper detection layer and the X driving electrodes or the Y driving electrodes provided at a lower side are arranged in the vertical direction without a metal layer interposed therebetween.

2. The input device according to claim 1,
wherein an upper surface of a flexible resin sheet having the upper detection layer formed on a lower surface thereof is adhered to a lower surface of a resin sheet having the X driving electrodes, the Y driving electrode, and the insulating layer formed on an upper surface thereof.

3. The input device according to claim 1,
wherein the upper detection layer is formed on a lower surface of a common resin sheet, and the X driving electrodes, the Y driving electrodes, and the insulating layer are formed on an upper surface of the common resin sheet.

4. The input device according to claim 1,
wherein the cover sheet comprises a plurality of laminated resin sheets.

5. The input device according to claim 1,
wherein a pressure detection region in which the lower detection layer faces the upper detection layer is wider than an electrostatic detection region in which the X driving electrodes face the Y driving electrodes.

6. The input device according to claim 5,
wherein extending portions that extend from the electrostatic detection region to both sides are provided in the capacitance-type detecting portion,
the insulating layer continuously extends from the electrostatic detection region to the extending portions, and
air passages are formed in the insulating layer.

7. The input device according to claim 5,
wherein the surface of the cover sheet protrudes in the electrostatic detection region.

8. The input device according to claim 1, further comprising:
a control unit that applies no voltage to the lower detection layer and the upper detection layer when a voltage is applied to the X driving electrode or the Y driving electrode.

9. The input device according to claim 8,
wherein, when the contact between the lower detection layer and the upper detection layer is detected, the control unit stops applying a voltage to the X driving electrodes and the Y driving electrodes, and applies a voltage to the lower detection layer and the upper detection layer.
